(19) United States
(12) Patent Application Publication
(10) Pub. No.: US 2002/0078164 A1
(43) Pub. Date: Jun. 20, 2002

(54) System and method for data transfer acceleration in a TCP network environment

(75) Inventor: Menachem Reinschmidt, Ra'anana (IL)

Correspondence Address: DR. Mark Friedman LTD, c/o Bill Polkinghorn-Discovery Dispatch, 9003 Florin Way, Upper Marlboro, MD, 20772, US

(73) Assignee: Marnetics Ltd.

(21) Appl. No.: 09/734,921

(22) Filed: Dec. 13, 2000

(51) Int. Cl. G06F 15/16

(52) U.S. Cl. 709/217; 709/203

(57) ABSTRACT

A system and method for increasing the efficiency of broadband information channels using an optimization engine that monitors, measures and controls actual data throughput in TCP networks. The optimization engine is implemented as a single sided proxy server, receiving, sending and controlling all data traffic in the network. The engine defines and monitors the TCP session capacity for individual channels, and generates responses to accelerate data flow speed, in existing access pipes. The engine generates and sends out fake acknowledgement messages to an information source, and influences data flow speed and accuracy by controlling the quantity, frequency and content of these messages. Furthermore the present invention enables maximizing the receive window size of clients by combining the available buffer capacity of multiple clients into shared memory space, and allocating usage of this space according to real time statistical calculations. The engine also checks the data received by clients for lost packets, and when discovered, initiates a fast recovery mechanism that includes sending of multiple duplicate fake acknowledgement messages to a relevant server.

### FIELD AND BACKGROUND OF THE INVENTION

The present invention relates to a system and method for increasing the efficiency of broadband information traffic using means that monitor, measure and control actual data throughput in Transmission Control Protocol (TCP) networks. This is achieved by defining and monitoring session capacity, and controlling session responses.

There is a significant gap between nominal bandwidth and effective throughput in broadband access pipes in TCP networks, due mainly to frequently congested routers throughout much of the Internet. In addition, Quasi-static routing (see “Measurements and analysis of End-to-End Internet Dynamics” by Vern Paxon—University of California, Berkeley, Calif., April 1997.) puts most of the responsibility for the actual transfer speed on TCP. There is therefore inefficient usage of access pipes at almost every point of access between broadband clients and servers.

TCP protocol controls the majority of Internet traffic. The TCP flow control, or way that TCP manages data flow, is thus crucial for data flow efficiency, as it determines the TCP session performance (effective throughput). Current TCP flow control works according to the following principles:

Data is transmitted in segments

There is a sliding window policy

The transmitter sends a batch of consequent segments according to the Transmission Window/Congestion Window (CWND)

Delayed acknowledgements (ACKs) are sent by the receiver

Lost packets are retransmitted

The receiver's Receive Window determines flow control.

Over the years, however, several improvements have been made on the basic TCP.

These include:

Slow start and Congestion Avoidance (RFC 1122)

Fast Retransmit and Fast Recovery (RFC 2001)

TCP Extensions for High Performance (RFC 1185/1323)

In spite of these improvements, there have, however, been major performance problems, and these have resulted in further solution seeking. For example:

RFC 2488: Enhancing TCP over Satellite Channels (January 1999)

RFC 2525: Known TCP Implementation Problems (March 1999)

RFC 2582: The NewReno Modification to TCP's Fast Recovery Algorithm (April 1999)

RFC 2757: Long Thin Networks (January 2000)

RFC 2760: Ongoing TCP Research related to Satellites (February 2000)

Continuing Internet development, in terms of both quantity of traffic and quality of data have outgrown current solutions. In response to these Internet access challenges, various alternative solutions and leading players in these segments have proposed the following solutions:

1. Caching solutions—effective where content is frequently used over a short period of time

2. Pre-fetching solutions—mainly client-side software solutions that overload the ISP network

3. Load balancing solutions—effective when Web-site servers are the bottleneck

4. Policy management/traffic shaping solutions—mainly prioritizing preferred customers over common customers

5. Web site offloading solutions—Offloading the Web site from heavy tasks frees its resources, thus increasing its capacity.

6. Compression-based accelerators—by installing compression/decompression software at both ends of a communication segment.

In spite of the above mentioned attempts to improve on the data throughput efficiency in TCP networks, the predominant current TCP architecture works as follows:

TCP breaks the incoming application byte stream into segments. The maximum size of a segment is called the MSS. A segment consists of a header, and some data. The last data byte in each segment is identified with a 32-bit byte count field in the segment header.

When a segment is received correct and intact, a special acknowledgement segment is returned to the sending server, containing the byte count of the last byte correctly received.

The network service can fail to deliver a segment. If the sending TCP waits for too long for an acknowledgment, it times out and resends the segment, on the assumption that the datagram has been lost. The network can potentially deliver duplicated segments, and can deliver segments out of order. TCP buffers or discards out of order or duplicated segments appropriately, using the byte count for identification. In addition to the issues of data loss and data duplication, TCP suffers from another major disadvantage. The server in a TCP network responds to the acknowledgement messages received from clients. The system, however, does not have any knowledge of the actual session capacity or potential. Therefore while there is available capacity, the TCP continues to send data on the assumption that there is available bandwidth. However when the point of capacity is reached, the TCP automatically ceases data transfer, and thereby allows the session capacity to be 100% available. However, this continual ceasing and restarting of data transfer wastes precious data transfer time, often shuts down the traffic flow temporarily causing accompanying problems, and provides a solution that does not optimize the session capacity.

There is thus a widely recognized need for, and it would be highly advantageous to have, a system that can minimize the gap between nominal bandwidth and effective throughput in broadband access pipes. There is also a widely recognized need for enhancing the current TCP protocol in order to maximize the efficiency of the existing network infrastructure, so that data can be transferred at higher speeds and with higher accuracy.

The present invention offers an alternative solution to the broadband Internet access bottleneck, based on manipulating the TCP protocol in order to attain fast data transfer and fast recovery of data loss.

The present invention minimizes the gap between nominal bandwidth and effective throughput by monitoring, tracing and controlling bi-directional data flow processes between both parties.

### SUMMARY OF THE INVENTION

According to the present invention there is provided a system for minimizing the gap between effective and nominal data throughput, by monitoring, tracing and controlling bi-directional data flow processes between both parties. The present invention includes a proxy server with an engine that uses an algorithm to monitor, measure and control data throughput. This is achieved by defining session capacity of individual sessions, tracing session progress, controlling session responses, and rapidly recovering packet losses. The consequence of this is an enhancement of the TCP/IP protocol, by causing TCP to send information at optimum speed, according to the following steps:

1. Identifying active sessions;

2. Defining and measuring on a real time basis the session capacity;

3. Analyzing incoming data packets from the server;

4. Separating packets to each concurrent active TCP session;

5. Sending a configured acknowledgement message to the server;

6. Emulating an infinite client in response to the server, by controlling the received window side in acknowledgement messages;

7. Deploying an Interpacket delay mechanism

8. Implementing an acceleration algorithm based on current, measured session capacity;

9. Remotely controlling the server control/data flow pace by controlling the timing of acknowledgement messages from the client;

10. Implementing fast duplicating acknowledgements for achieving fast recovery of lost packets.

11. The present invention manipulates acknowledgement information from the client side, causing the TCP network to send information faster or slower, as well as rapidly recovering lost packets. The components of the present invention include:

A PEP (Performance Enhancement Proxy) server, which is a proxy server referred to within this document as BITmax.

A Session Management Engine or optimizer in the above mentioned server.

A set of algorithms, referred to as a scalable TCP/IP connectivity (STIC) algorithm, within the above mentioned optimizer.

### BRIEF DESCRIPTION OF THE DRAWINGS

The invention is herein described, by way of example only, with reference to the accompanying drawings, wherein:

FIG. 1 is a flow chart representing where and how the Bitmax server of the present invention functions, between the BITmax and the Server

FIG. 2 is a flow chart illustrating the basic functioning of the present invention between a client and the Bitmax server.

### DESCRIPTION OF THE PREFERRED EMBODIMENT

The present invention is of a system and method for increasing the efficiency of broadband information traffic. This is achieved by using a proxy server with an optimization engine that monitors, measures and controls data throughput. Accordingly, the present invention defines session capacity, increases client capacity and session memory, and recovers lost data and controls session responses so as to achieve optimum efficiency when using a communication network.

1. Specifically, the present invention can be used to manipulate data acknowledgement information from the client side, causing the TCP network to send information faster or slower, as well as recover lost packets. The present invention may be in the form of a box that sits at the first router or hop at the point of Internet access (point of concentration). It may sit at or near an ISP or a Web server, receiving and forwarding all traffic to and from that point. The proxy server of the present invention is single sided, in that it requires specific software only from the server side or the client side. In this way the user at the client side does not need to act in any way to set up the system, and it operates in a transparent way towards the user. Once set up, it also operates in a transparent way towards the server. The setup of the system requires specific software only on the server side or the client side. in the typical embodiment of the present invention. However it is also optional to install the Bitmax server with its optimization engine software at any point in a TCP network, between or within any servers and/or clients.

The components of the present invention include:

i. A front end PEP (Performance Enhancement Proxy) server: This server is installed as a transparent front-end performance gateway in a Web server environment. This server is interoperable with every TCP/IP client, with no software installation required on the client side. This proxy server sits between end-to-end users, and is responsible for sending and receiving all data between client and server stations.

ii. An optimization engine that is implemented as a Session Management Engine. This engine or optimizer is a software component installed in the PEP server, that analyses active sessions, monitors individual sessions as well as the overall picture of the Bandwidth Balance, and generates responses based on session data.

iii. A scalable TCP/IP connectivity algorithm (STIC algorithm) that analyses the session data in order to calculate the actual session capacity, and appropriate responses. The optimization engine run this algorithm, enabling the system to automatic make decisions based on real time information, and accordingly to initiate responses in order to optimize data flow.

The principles and operations of such a system according to the present invention may be better understood with reference to the FIGURES and the accompanying descriptions, wherein:

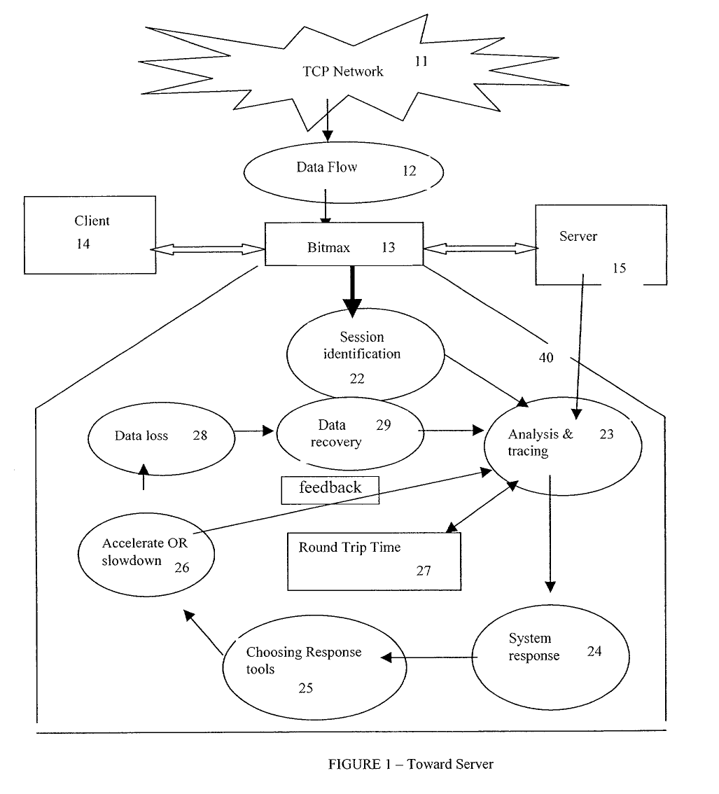

FIG. 1 is a flow chart that represents where the proxy server 13 of the present invention (called BITmax server) functions in the TCP network, according to its preferred embodiment. In this case, the present invention operates as a transparent intermediate performance enhancement proxy in a TCP network environment. The Bitmax server 13 sits in between or inside any chosen servers 15 or clients 14. It receives all data traffic and sends all data traffic between any points. In the process of receiving and forwarding data, the Bitmax server analyses all data, including header messages, packet data and acknowledgement messages. It is transparent in that it does not require setup at the client side, and nor neither the client nor the server are aware of its functioning at all. It acts as a client towards a server, and as a server towards a client.

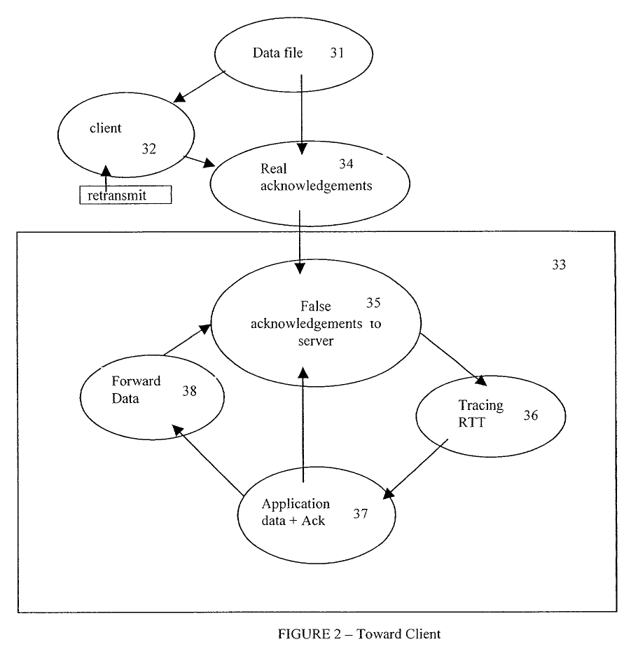

According to the preferred embodiment of the present invention, there is a method and system for accelerating data traffic using means that monitor, measure and control actual data throughput in TCP networks. This is achieved by the following steps, with reference to FIGS. 1 and 2:

Step 1: Identifying and tracing currently active TCP sessions on a per session basis

Step 2: Measuring current session capacity, based on Round Time Trip (RTT)) measurements of each active session, and tracing session capacity trends.

Step 3: Responding to session capacity trends.

Step 4: Application of tools to optimize data transfer.

Step 5: Monitoring session progress and providing feedback to the optimization engine for continual trend analysis.

Step 6: Identifying and responding to data losses.

Following is a more detailed outline of how the present invention operates according to the previously mentioned steps:

Step 1: Upon receiving data 12 from a server, the optimization engine (which is included within the Bitmax Server 13) identifies and traces 22 the currently active TCP session on a per session basis, including:

i. identifying session establishment procedure;

ii. identifying session disconnection procedure; and

iii. extracting and registering relevant session parameters in an active sessions data base.

This process enables the optimization engine to interact fully with each of the active clients, and to use the shared memory capabilities of the various active clients to increase the client receive windows and thereby achieve optimum efficiency for data transfer.

Step 2: The optimization engine then analyses and measures 23 the current session capacity, based on Round Time Trip (RTT) 27 measurements of each active session, and traces session capacity trends. The use of RTT 27 and reverse RTT to measure session capacity provides an accurate way of determining effective data throughput. The optimization engine 13 analyses and monitors both the individual user sessions and the overall or combined capacity of a TCP network at a given time. This process includes the following steps:

a) Between the proxy server 33 and the client 32 in FIG. 2

i. receiving application data 31 from a server 33;

ii. immediately forward the data 31 to the client 32, according to actual client receive window size;

iii. receiving real acknowledgement messages 34 from the client 32, and generating fake acknowledgement message/s 35 based on real acknowledgement message/s 34 received.

iv. forwarding fake acknowledgement 35 message to the server 33, and tracing 36 Round Trip Time (RTT).

v. checking 37 if acknowledgement messages carry application data in addition to the acknowledgement message. If they do, forward 38 the application data 37 within the fake acknowledgement message 35;

vi. verify that all information was received by client 32;

vii. in the case where all information segments were not received, segments are retransmitted to client 32;

viii. when information received is verified, erase sent data from output queue towards client 32;

b) Between proxy server and chosen server:

i. generating a fake acknowledgement message 35 (in FIG. 2) based on real acknowledgement messages received from the client 32;

ii. sending fake acknowledgement messages 35 to the server 33;

iii. receiving data from the server 33 and measuring current effective throughput by means of Bytes per Second (BpS).

iv. measuring the last reverse round trip time (reverse RTT) 27, which is the time difference between sending one of the fake acknowledgement messages and the time at which the first bite of data is received from the server in response to the fake acknowledgement message.

v. maintaining a record of (n) previous reverse RTT's 27;

vi. executing an algorithm on the information collected from said recording of previous reverse RTT's 27 and said tracing, to formulate trends and make estimations of future said bursts, which provides an indication of current status of session;

Step 3: Responding to session capacity trends, including sending out false acknowledgement messages to the server and controlling the timing/frequency and content of fake acknowledgement messages 35. The optimization engine, for example, can send duplicate acknowledgement messages or alternatively send fewer acknowledgement messages than the number of true acknowledgement messages that should be sent to a server. This is decided according to the following guidelines:

a) if the session capacity/status is slowing down, the BITmax server 13 acts to slow down data transfer by one or more of the following steps:

(1) reducing size of the receive window stated in fake acknowledgement messages 35;

(2) increasing the number of acknowledged data bytes 34 acknowledged by fake acknowledgement messages 35;

(3) increasing time intervals between fake acknowledgement messages 34 and data segments.

b) if the session capacity/status is underutilized, said BITmax server 13 acts to accelerate data transfer to use available capacity by one or more of the following steps:

(1) increasing size of the receive window stated in fake acknowledgement messages 35. The optimization engine 13 can combine the receive buffers (the data receiving memory capacity) of the various clients into a shared common memory which is distributed among the clients. In this way the receive window representing the data receiving capacity of clients is greatly enhanced.

(2) reducing the number of acknowledged data bytes acknowledged 34 by each fake acknowledgement messages 35;

(3) reducing time intervals between fake acknowledgement messages 35 and data segments 34.

c) if the session capacity/status is at or close to optimum utilization, said proxy server monitors current session status and maintains current performance.

Step 4: Application of tools 25 to optimize data transfer, including:

i. Interpacket delay within any consequent data-only flow. This tool is valid for server side configurations only.

ii. controlling receive window size of client by emulating an infinite client, including maximizing receive windows and allocating shared memory to serve individual clients. An infinite client is a term illustrating the process by which the Bitmax server emulates the client capacity towards the server. In this way, the server believes that the client whom it is communicating with, which is actually the Bitmax server, has a very large data receiving capacity. The cumulative capacity of such an action can prove to be even larger than the data sending capacity of the server, and so it may appear to have infinite capacity. This is achieved by allocating the cumulative receive buffer capacity to clients, according to statistically based dynamic allocation per session; and

iii. using compiled tracing information (session capacity and trends) to determine content and frequency of fake acknowledgement messages, to manipulate data transfer rates in order to achieve optimum speed and accuracy.

Step 5: Monitoring session progress, and using this monitoring in order to make automatic decisions whether to accelerate or slowdown 26 data transfer, and providing feedback to the optimization engine, which continues to trace and respond to session capacity on a real time basis.

Step 6: In the process of receiving data packets from the server, identifying and responding to data losses 28, including:

i. identify situation of lost packets by tracing sequence numbers of packets received from the server, by tracing sequence numbers of packets received from the server and calculating where data packets have not been received by the client and/or BITmax;

ii. when recognized, activate a fast retransmission mechanism 29 to recover lost packets rapidly. This includes sending multiple (duplicate) acknowledgement messages where the acknowledgement number corresponds to the last received byte before the lost data packet;

iii. after receiving a lost segment, send a fake acknowledgement message 35 that acknowledges the lost segment and all the other consequent data packets that were correctly received. For example, if packets 4,5,6,8.9 were received initially, duplicate acknowledgement messages may have been sent that 6 was received, causing the server to send 7. Once received, the optimization engine may send acknowledgement messages for packets 8 and 9 in order to cause the server to continue sending packets 10, 11 etc.

Session Capacity, although an unknown concept before the present invention, is the predominant factor in determining the transmission pace across the TCP/IP network. The analysis and monitoring of session capacities according to the present invention is achieved through using the STIC algorithm: This algorithm, or more accurately a group of algorithms, stands for Scalable TCP/IP Connectivity (STIC) algorithm. It is the combination of procedures discussed above by which the optimization engine analyzes, calculates, monitors session capacity of a TCP network and takes decisions how to best respond in order to optimize data flow. The various components of the STIC algorithm are:

i. session identifier—recognizes start of session and sends data to analysis module. Also recognizes end of session.

ii. Tracing and analysis—keeps the sessions parameters, measures, recognizes trends and reports to the response handler. Also responsible for tracing session behavior after activating the response tools.

iii. System response (Response handler)—chooses the right response tool to use:

Accelerate, slow-down or unchanged.

iv. Data Loss recognition and recovery—recognizing packet loss and activating request for retransmission and conducting fast recovery.

Advantages of the Present Invention:

Smooths congested routers when installed near the server side, not just by reducing the CWND (Congestion Window), but also by increasing the Inter Packet Delay.

Estimates and utilizes the currently available bandwidth of the virtual end-to-end pipe.

Provides full control over the overall bandwidth balance in a certain Web site

Responds effectively to lost packet situations.

Creates a new state machine that better tracks and responds to the session dynamics.

Responds to real time trends, as well as to discrete situations.

Another way that this system can be used is by stationing the Bitmax server at the server side or at any other point along the TCP path, including within a server and/or within a client. This includes the servers of carriers, PTT's, ISP's, Web hosting companies' etc.

While the invention has been described with respect to a limited number of embodiments, it will be appreciated that many variations, modifications and other applications of the invention may be made.

What is claimed is:

1. A system for optimizing data transfer at any point in time in a TCP network, comprising:
i. TCP network for transferring data between at least two computer devices;
ii. client for accessing Internet using said TCP network;
iii. server for transferring content over said TCP network; and
iv. proxy server for receiving and forwarding all data sent between servers and clients in a network, thereby emulating a server towards a client, and emulating a client towards a server in said TCP network.

2. The system of claim 1, wherein said proxy server incorporates an optimization engine for tracking and controlling data throughput in a TCP network from within said proxy server.

3. The system of claim 1, wherein said proxy server is positioned between any server and client, and controls all data and messages transferred between said server and said client.

4. The system of claim 1, wherein said proxy server is positioned within any server or within any client, and controls all data and messages transferred between said server and said client.

5. The system of claim 2, wherein said proxy server is single sided, stationed only at the server side.

6. The system of claim 2, wherein said proxy server is single sided, stationed only at the client side.

7. The system of claim 2, wherein said optimization engine uses a Scalable TCP/IP Connectivity (STIC) algorithm to monitor data flow in said TCP network.

8. The system of claim 7, wherein said scalable TCP/IP connectivity (STIC) algorithm is further used to track, analyze and control data flow in said TCP network

9. The system of claim 2, wherein said optimizer monitors, traces and controls bi-directional data flow between two or more parties.

10. The system of claim 2, wherein said optimization engine monitors real time session capacity of TCP sessions.

11. The system of claim 2, wherein said optimization engine is operative to forward packets unchanged, modify packets, generate new packets and discard packets.

12. The system of claim 2, wherein said optimization engine monitors and traces the overall available bandwidth in a TCP network.

13. A method for increasing efficiency of data transfer in a TCP network, comprising the steps of:
i. identifying and tracing currently active TCP sessions on a per session basis;
ii. measuring current session capacity for individual active sessions.
iii. tracing session capacity trends; and
iv. generating fake acknowledgement messages to remotely manipulate server behavior, according to the current session capacity.

14. The method of claim 13, wherein said tracing session capacity trends is achieved according to the following steps:
i. maintaining a record of previous Round Trip Time; and
ii. formulating trends and estimating session condition based on said previous Round Trip Time.

15. The method of claim 13, wherein said execution of responses includes manipulating the frequency of said fake acknowledgement messages.

16. The method of claim 13, wherein said execution of responses includes manipulating the content of said fake acknowledgement messages.

17. The method of claim 15, wherein said execution of responses further comprises emulating an infinite client by combining the receive buffers of multiple clients into a shared common memory.

18. The method of claim 17, wherein said emulating an infinite client further comprises controlling receive window size of client in said fake acknowledgement messages.

19. The method of claim 17, wherein said emulating an infinite client further comprises allocating on dynamic basis a large amount of shared memory buffers in a proxy server for a group of sessions, enabling those sessions to increase their receiving capacity.

20. The method of claim 13, further comprising monitoring session responses to said data transfer manipulation in order to provide real time feedback for said trends tracing.

21. The method of claim 13, wherein the method for increasing the efficiency of data transfer in a TCP network, further comprises the steps of:
i. identifying situations of packets not received by mechanisms selected from the group consisting of clients and servers;
ii. activating a fast retransmission mechanism (multiple duplicate acknowledgment messages) to recover said lost packets; and
iii. sending a fake acknowledgement message that acknowledges said lost packet and all the other consequent data packets that were correctly received.

22. A method for determining session capacity at any given time in a TCP network, comprising:
i. Identifying individual active sessions;
ii. Generating fake acknowledgement messages based on real acknowledgement messages received from a client;
iii. Sending said fake acknowledgement messages to a server; and
iv. Analyzing individual session data transfer rates based on RTT (Round Trip Time) trends.
